(19) United States
(12) Patent Application Publication
(10) Pub. No.: US 2025/0164959 A1
(43) Pub. Date: May 22, 2025

(54) METHODS AND APPARATUS TO TRANSFORM PROCESS CONTROL DATA FOR USE IN A DISTRIBUTED CONTROL SYSTEM

(71) Applicant: Fisher-Rosemount Systems, Inc., Round Rock, TX (US)

(72) Inventors: Cody Aaron Long, Pflugerville, TX (US); James Aaron Crews, Cedar Park, TX (US); Shivkumar Rambabu Kada, Pune (IN)

(21) Appl. No.: 18/611,061

(22) Filed: Mar. 20, 2024

Related U.S. Application Data
(60) Provisional application No. 63/599,732, filed on Nov. 16, 2023.

(51) Int. Cl. G05B 19/05

(52) U.S. Cl. CPC G05B 19/052; G05B 2219/13004

(57) ABSTRACT

Systems, apparatus, articles of manufacture, and methods are disclosed to transform process control data for use in a distributed control system. An example apparatus includes first instructions to access an output condition associated with a process control system, determine second instructions to control the system based on the output condition, the second instructions executable by a programmable logic controller (PLC), identify a pattern based on the second instructions and the output condition, compare the pattern to stored patterns in a first database, the stored patterns associated with at least one other process control system, determine a control narrative when the pattern matches at least one of the stored patterns, the control narrative corresponding to the at least one of the stored patterns, and transmit the control narrative to a second database associated with a distributed control system (DCS), the control narrative to modify a configuration of the DCS.

### RELATED APPLICATION

This patent claims priority to U.S. Provisional Patent Application No. 63/599,732, which was filed on Nov. 16, 2023. U.S. Provisional Patent Application No. 63/599,732 is hereby incorporated by reference in its entirety.

### FIELD OF THE DISCLOSURE

This disclosure relates generally to process control systems and, more particularly, to methods and apparatus to transform process control data for use in a distributed control system.

### BACKGROUND

Process control systems, like those used in chemical processing, petroleum processing or other processes, typically include one or more process controllers that may be communicatively coupled to one or more field devices via analog, digital or combined analog/digital buses. The process controllers receive signals indicative of process measurements and then process this information to generate control signals, implement control routines, and make other process control decisions. As newer, improved process control system hardware and software applications become available, companies may update or replace their previous process control system with the improved hardware and software applications.

### BRIEF DESCRIPTION OF THE DRAWINGS

FIG. 1 is a block diagram of an example migration and data transformation for an example process control system.

FIG. 2 is a block diagram of an example implementation of the data transformer circuitry of FIG. 1.

FIG. 3 is an example process flow which the example data transformer circuitry of FIG. 1 may implement.

FIGS. 4 and 5 illustrate example ladder diagrams that can be implemented by examples disclosed herein.

FIGS. 6 and 7 illustrate example implementations of the ladder diagrams of FIGS. 4 and 5.

FIG. 8 is a flowchart representative of example machine readable instructions and/or example operations that may be executed, instantiated, and/or performed by example programmable circuitry to implement the data transformer circuitry of FIG. 2.

FIG. 9 is a block diagram of an example processing platform including programmable circuitry structured to execute, instantiate, and/or perform the example machine readable instructions and/or perform the example operations of FIG. 8 to implement the data transformer circuitry f FIG. 2.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Process control system architectures have evolved over many years from systems employing primarily electromechanical devices such as relays and contactors to implement the logic of a control routine or application, to programmable logic controller (PLC) based systems and, more recently, to distributed control systems (DCSs). Process control systems employing a DCS architecture, like those used in chemical processes, petroleum processes or other processes, typically include one or more centralized process controllers communicatively coupled to at least one host or operator workstation and to one or more field devices via analog, digital or combined analog/digital buses. The field devices, which may be, for example, valves, valve positioners, switches and transmitters (e.g., temperature, pressure and flow rate sensors), perform functions within the process such as opening or closing valves and measuring process parameters. The process controllers receive signals indicative of process measurements made by the field devices and/or other information pertaining to the field devices, uses this information to implement a control routine, and then generates control signals that are sent over the buses or other communication lines to the field devices to control the operation of the process. Information from the field devices and the controllers may be made available to one or more applications executed by the operator workstation to enable an operator to perform desired functions with respect to the process, such as viewing the current state of the process, modifying the operation of the process, etc.

Process control systems are typically configured using configuration applications that enable a system engineer, operator, user, etc., to define how each field device within a process control system should function for a particular process (e.g., a particular chemical production process). When a field device is added to a particular process or each time a change is made to the process, an engineer may generate a new control program or new configuration data or may update or modify an existing control program. Each process may use a large number of field devices, controllers, and/or other control devices and, thus, a control program may include large amount of configuration data. Some known process control systems provide integrated editors that enable users to create and/or update control programs. However, these known programs typically display data in a manner that does not reveal how process control data associated with one field device relates to the process control data of another field device. Furthermore, the underlying database infrastructure does not show the relationships between the control system, the process, material flows and compositions, equipment, devices, and the operational displays that are used to operate, maintain, and diagnose the overall system. In other words, these known editors typically show process control data without revealing its relationship to the overall system.

As newer, improved process control system hardware and software applications (hereinafter referred generally as process control system applications) become available, companies may choose to upgrade their older process control systems applications. Upgrading or migrating an existing process control system application to a newer, different process control system application is often very time consuming and, as a result, expensive, because of incompatibilities between older process control system application and the newer process control system application. Such a migration can be particularly difficult when there are significant architecture, data format and programming language differences between the older and the newer process control system applications. For example, migrating a process control system application implemented within an architecture based on programmable logic controllers to a distributed control system architecture can be very challenging and time consuming. In particular, control instructions and, more generally, data formats may differ between these different process control system architectures and related applications. As a result, migrating existing process control data (e.g., control instructions) often requires engineers to migrate the data manually and/or to develop custom scripts or programs that can convert or transform the prior custom data (e.g., data compatible with a PLC based system) to data that is formatted to be suitable for use with the new process control system application (e.g., a DCS application).

Examples disclosed herein enable a streamlined migration from a previous process control system application (e.g., a PLC application) to a different process control system application (e.g., a DCS application). Examples disclosed herein substantially reduce or eliminate the manual effort needed to develop configurations to implement the control routines of the process control system being migrated within the updated process control system application. Further, disclosed examples ensure the database infrastructure associated with the updated process control system application includes (or can otherwise access) relationships between the different components of the process control system (e.g., the process, alarms, notifications, equipment, field devices, operational displays, etc.). In some examples, disclosed examples access graphical representations (e.g., ladder diagrams) of the process control systems that illustrate (e.g., demonstrate, include, etc.) such relationships.

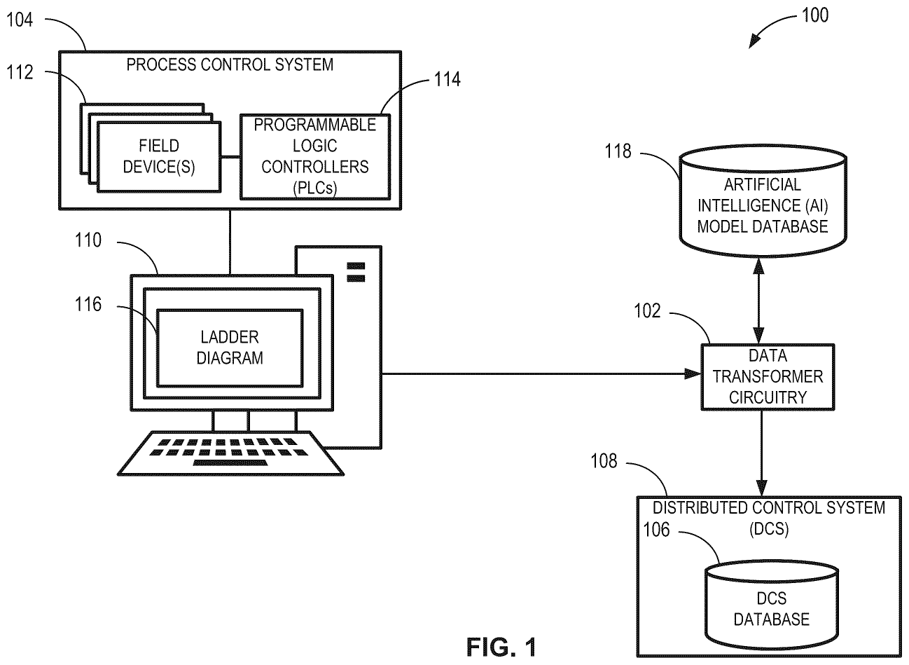

FIG. 1 is a block diagram of an example environment 100 in which example data transformer circuitry 102 operates to migrate data from an example PLC-based process control system 104 to an example DCS database 106 of an example DCS 108. The example data transformer circuitry 102 may be implemented by and/or included within an example workstation 110. In other examples, the data transformer circuitry 102 may be included within a server and/or any other computing device(s) that may be communicatively coupled to the workstation 110. The example process control system 104 may include any type of manufacturing facility, process facility, automation facility, and/or any other type of process control structure or system.

As shown in FIG. 1, the example process control system 104 includes example field devices 112. The example field devices 112 may include any type(s) of process control component(s) capable of receiving inputs, generating outputs, and/or controlling a process. For example, the field devices 112 may include valves, pumps, fans, heaters, coolers, strippers, tanks, drums, coalescers, separators, reactors, compressors, motors, desalters, piping, etc., to control a process. Additionally, the field devices 112 may include measurement or monitoring devices such as temperature sensors, pressure sensors, concentration sensors, fluid level meters, flow meters, and/or vapor sensors to measure portions of a process. The example field devices 112 receive instructions from one or more example PLCs 114 to execute specified operations and/or cause a change to the process implemented and/or controlled by the field devices 112. Further, the example field devices 112 measure process data, environmental data, and/or input device data and transmit the measured data (and any other configuration settings) to the PLCs 114.

The example PLCs 114 of the illustrated example are in communication with the example workstation 110 (e.g., via a network). The example workstation 110 can be a personal computer, a desktop computer, a server, a laptop computer, a mobile device (e.g., a smartphone, a tablet computer, etc.). In some examples, the workstation 110 can execute an application (e.g., a software application, a process control system application, etc.) to control and/or monitor portions of the process control system 104. In some examples, the application can include a graphical user interface (GUI) to facilitate interaction between a user (e.g., an engineer, maintenance personnel, an operator, a supervisor, a technician, etc.) and the process control system 104. Additionally, the application can be represented in at least one of a graphical programming language (e.g., ladder diagrams, functional block diagrams (FBDs), sequential function charts (SFCs), etc.) or a textual programming language (e.g., structured text (ST), instruction list (IL), etc.). For purposes of explanation, examples disclosed herein are described with applications represented as a ladder diagram (e.g., an example ladder diagram 116). However, examples disclosed herein may be implemented with any type of application.

The example data transformer circuitry 102 is configured to extract the example process control system application data (e.g., the ladder diagram 116) and transmit the application data to the DCS 108 and/or the DCS database 106. In this example, the data transformer circuitry 102 can convert or transform the process control data (e.g., control logic or instructions) from a first data format compatible with the PLCs 114 to a second data format compatible with the DCS 108. In the example DCS 108, field devices may be distributed across a network and/or one or more geographical locations and/or network locations. As such, other example workstations may access the process control data (e.g., the ladder diagram 116, the instructions, the control narratives, etc.) from such a network in the DCS 108. In some examples, the data transformer circuitry 102 is coupled to an example artificial intelligence (AI)/machine learning (ML) model (e.g., in an example AI model database 118) to facilitate the conversion or transformation of the process control data from the PLCs 114 to the DCS 108.

AI, including ML, deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) results in output(s) consistent with the recognized patterns and/or associations.

The example AI model can be trained to operate in accordance with patterns and/or associations based on, for example, the process control data. The model includes internal parameters that guide how input data is transformed into output data, such as through a series of nodes and connections within the model to transform input data into output data. Additionally, hyperparameters may be used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the ML/AI architecture and/or the expected output of the model. For example, supervised training uses inputs and corresponding expected (e.g., labeled) outputs to select parameters (e.g., by iterating over combinations of select parameters) for the model that reduce model error. Alternatively, unsupervised training (e.g., used in DL) involved inferring patterns from inputs to select parameters for the model (e.g., without the benefit of expected outputs). The training algorithm may be implemented using hyperparameters that control how the learning is performed (e.g., a learning rate, a number of layers to be used in the classification model, etc.). In some examples, retraining may be performed.

Because supervised training is used, the example training data is organized (e.g., sorted) into classifications (e.g., categories, labels, etc.). Labels may be applied to the training data manually. Additionally or alternatively, labeling may be applied using historical (e.g., stored) data from an example company utilizing example values for process control data classification described herein.

The example AI model database 118 of FIG. 1 stores one or more versions of the example classification model. The example AI model database 118 is implemented by any memory, storage device and/or storage disc for storing data such as, for example, flash memory, magnetic media, optical media, solid state memory, hard drive(s), thumb drive(s), etc. Furthermore, the data stored in the AI model database 118 may be in any data format such as, for example, binary data, comma delimited data, tab delimited data, structured query language (SQL) structures, etc. While, in the illustrated example, the AI model database 118 is illustrated as a single device, the AI model database 118 and/or any other data storage devices described herein may be implemented by any number and/or type(s) of memories.

The example data transformer circuitry 102 accesses the classification model from the AI model database 118 (e.g., via a network). The example data transformer circuitry 102 operates the classification model in an inference phase to process data. In the inference phase, the example process control data (e.g., the ladder diagram 116) obtained from the process control system 104 and/or the workstation 110 are inputs to the classification model, and the classification model executes to output data. The output data of the data transformer circuitry 102 includes control narrative(s) that describe and/or represent the process control system 104. The example data transformer circuitry 102 can generate the control narratives based on similarities between the patterns associated with the instructions from the ladder diagram 116 and stored patterns in the AI model database 118. This inference phase can be thought of at the AI “thinking” to generate the output based on what it learned from the training (e.g., by executing the classification model to apply the learned patterns and/or associations to the input data). In some examples, input data undergoes pre-processing before being used as an input to the classification model. Moreover, in some examples, the output data may undergo post-processing after it is generated by the classification model.

In some examples, output of the model may be captured and provided as feedback to the data transformer circuitry 102 (e.g., via a network). By analyzing the feedback, an accuracy of the example model can be determined. If the feedback indicates that the accuracy of the example model fails to satisfy a threshold or other criterion, training of an updated model can be triggered using the feedback and an updated training data set, hyperparameters, etc., to generate an updated, deployed classification model.

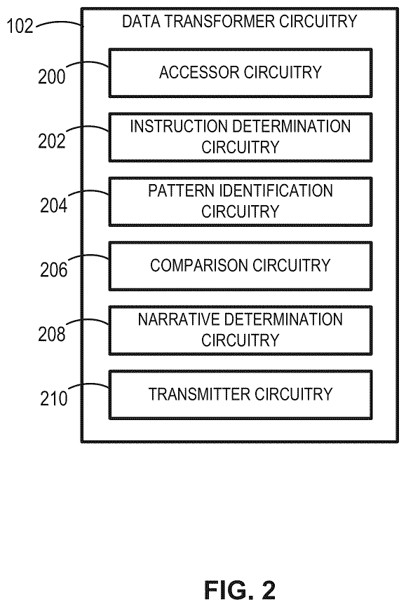

FIG. 2 is a block diagram of an example implementation of the data transformer circuitry 102 of FIG. 1 to migrate process control data to a DCS. The example data transformer circuitry 102 includes example accessor circuitry 200, example instruction determination circuitry 202, example pattern identification circuitry 204, example comparison circuitry 206, example narrative determination circuitry 208, and example transmitter circuitry 210. The data transformer circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the data transformer circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

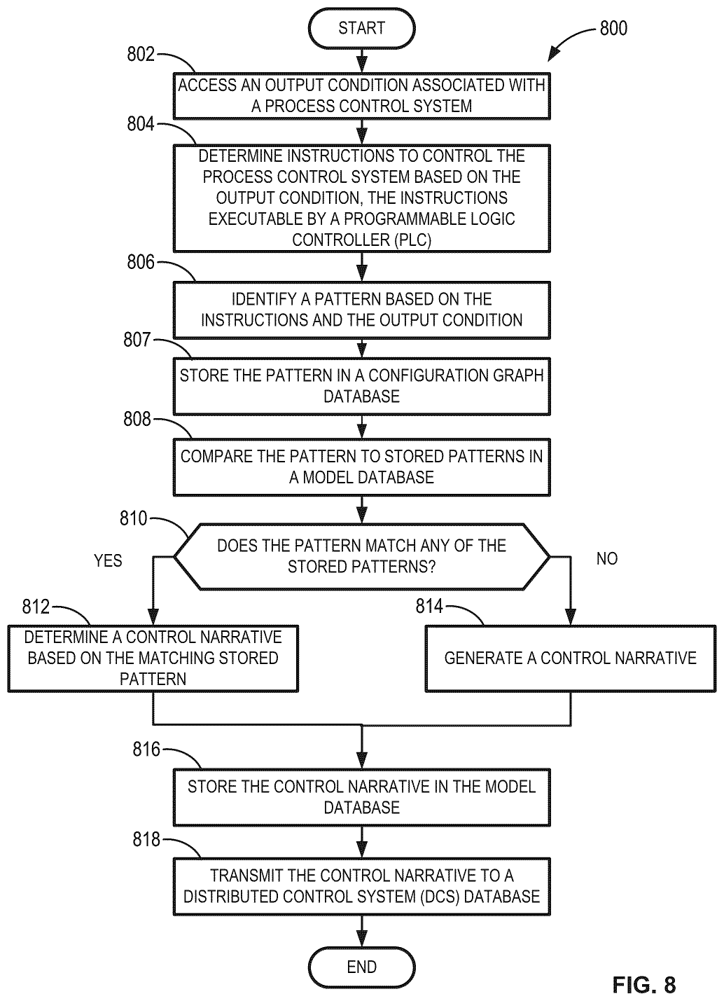

The example accessor circuitry 200 accesses an example output condition associated with an example process control system. For example, the accessor circuitry 200 can access an output condition associated with one of the field devices 112 associated with the process control system 104. In some examples, an output condition can indicate an operation of one of the field devices 112. For example, if one of the field devices 112 is a pump, then the output condition can indicate that the pump is “On” (e.g., running, operative, started, etc.), “Off” (e.g., shutdown, stopped, etc.), etc. Alternatively, if one of the field devices 112 is a valve, then the output condition can indicate that the valve is “Open,” “Closed,” etc. In other examples, if one of the field devices 112 is a cooler, then the output condition can indicate that the cooler is “Started,” “Stopped,” etc. In some examples, measurement devices associated with the field devices 112 can detect and/or monitor such output conditions. Further, the example ladder diagram 116 can indicate the output conditions associated with the process control system 104. As such, the example accessor circuitry 200 can access an example output condition via the ladder diagram 116. In some examples, the ladder diagram 116 may include multiple output conditions, multiple input conditions, or any other kind of data (e.g., equipment information, device alarms, etc.). The example accessor circuitry 200 can access such information from the ladder diagram 116. In some examples, the accessor circuitry 200 is instantiated by programmable circuitry executing accessor instructions and/or configured to perform operations such as those represented by the flowchart of FIG. 8.

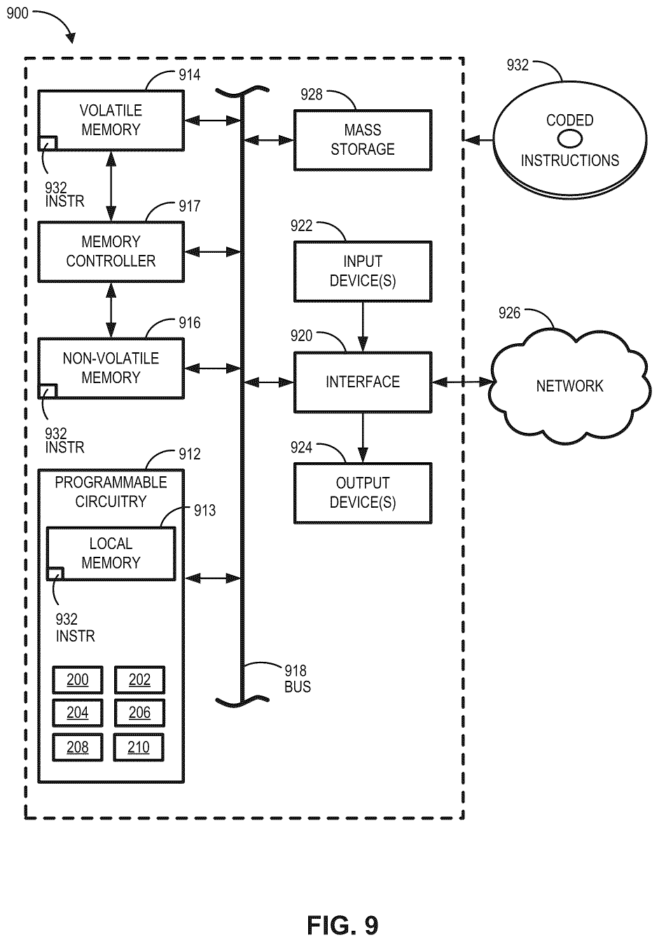

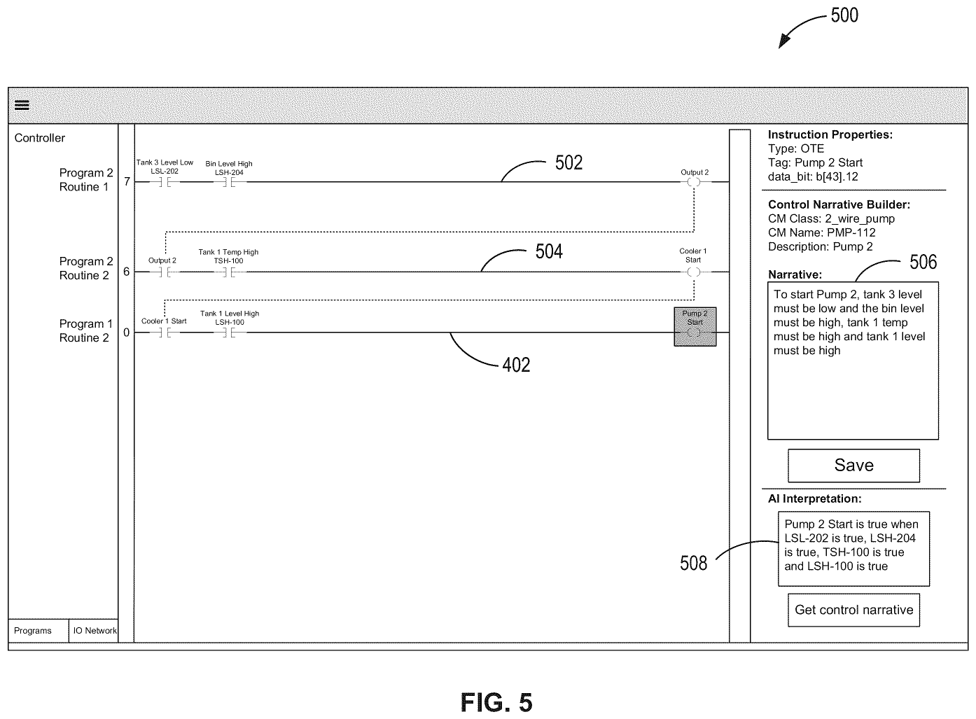

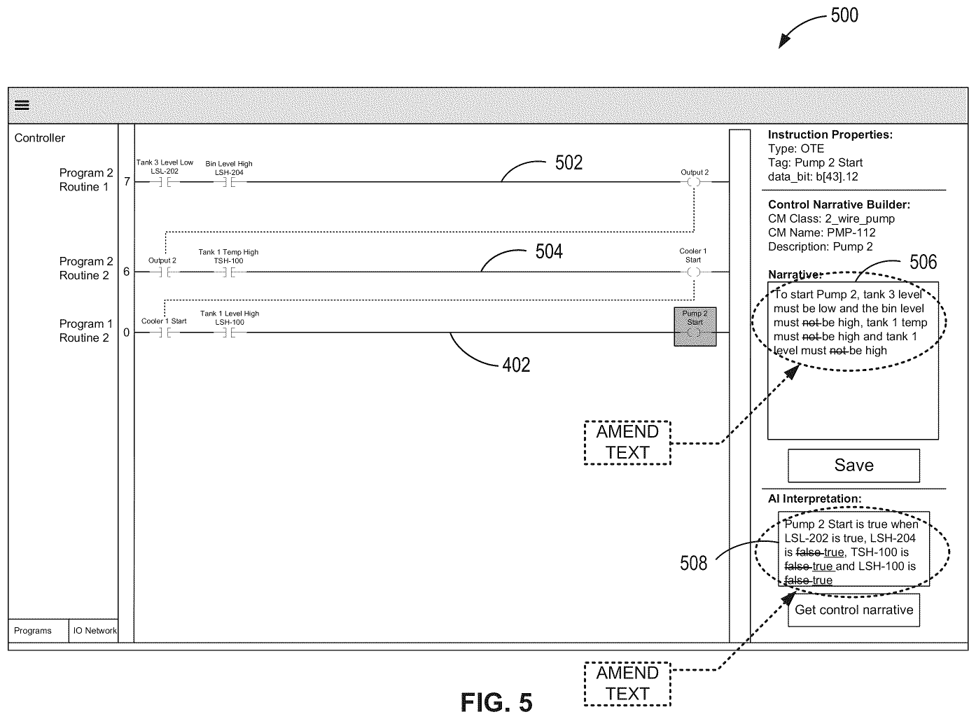

In some examples, the data transformer circuitry 102 includes means for accessing an output condition. For example, the means for accessing may be implemented by accessor circuitry 200. In some examples, the accessor circuitry 200 may be instantiated by programmable circuitry such as the example programmable circuitry 912 of FIG. 9. For instance, the accessor circuitry 200 may be instantiated by an example microprocessor executing machine executable instructions such as those implemented by at least block 802 of FIG. 8. In some examples, accessor circuitry 200 may be instantiated by hardware logic circuitry, which may be implemented by an ASIC, XPU, or FPGA circuitry configured and/or structured to perform operations corresponding to the machine readable instructions. Additionally or alternatively, the accessor circuitry 200 may be instantiated by any other combination of hardware, software, and/or firmware. For example, the accessor circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example instruction determination circuitry 202 determines example instructions to control the process control system 104 based on the output condition. For example, the instruction determination circuitry 202 can determine instructions used by the PLCs 114 to execute specified operations (e.g., control the field devices 112). As such, the example instructions are executable by the PLCs 114. In some examples, the instruction determination circuitry 202 can determine instructions to achieve (e.g., complete) the output condition. For example, the ladder diagram 116 can include instructions (e.g., conditions, inputs, etc.) that at least one of the field devices 112 executes to achieve the output condition (e.g., turn on). In some examples, the instruction determination circuitry 202 is instantiated by programmable circuitry executing instruction determination instructions and/or configured to perform operations such as those represented by the flowchart of FIG. 8.

In some examples, the data transformer circuitry 102 includes first means for determining instructions. For example, the first means for determining may be implemented by instruction determination circuitry 202. In some examples, the instruction determination circuitry 202 may be instantiated by programmable circuitry such as the example programmable circuitry 912 of FIG. 9. For instance, the instruction determination circuitry 202 may be instantiated by an example microprocessor executing machine executable instructions such as those implemented by at least block 804 of FIG. 8. In some examples, the instruction determination circuitry 202 may be instantiated by hardware logic circuitry, which may be implemented by an ASIC, XPU, or FPGA circuitry configured and/or structured to perform operations corresponding to the machine readable instructions. Additionally or alternatively, the instruction determination circuitry 202 may be instantiated by any other combination of hardware, software, and/or firmware. For example, the instruction determination circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example pattern identification circuitry 204 identifies an example pattern based on the instructions and the output condition. In some examples, the pattern identification circuitry 204 identifies an example pattern by observing (e.g., recording, determining, etc.) dependencies within the instructions. For example, the ladder diagram 116 can include input data and output data. In some examples, the output data can include a first output condition and a second output condition, where the first output condition serves as input data for the second output condition. As such, the example pattern identification circuitry 204 can identify the pattern in the instructions based on dependencies between the first output condition, the second output condition, and any other input data from the ladder diagram 116. In some examples, the pattern identification circuitry 204 can store the patterns in an example configuration graph database. In some examples, the pattern identification circuitry 204 is instantiated by programmable circuitry executing pattern identification instructions and/or configured to perform operations such as those represented by the flowchart of FIG. 8.

In some examples, the data transformer circuitry 102 includes means for identifying a pattern. For example, the means for identifying may be implemented by pattern identification circuitry 204. In some examples, the pattern identification circuitry 204 may be instantiated by programmable circuitry such as the example programmable circuitry 912 of FIG. 9. For instance, the pattern identification circuitry 204 may be instantiated by an example microprocessor executing machine executable instructions such as those implemented by at least blocks 806, 807 of FIG. 8. In some examples, pattern identification circuitry 204 may be instantiated by hardware logic circuitry, which may be implemented by an ASIC, XPU, or FPGA circuitry configured and/or structured to perform operations corresponding to the machine readable instructions. Additionally or alternatively, the pattern identification circuitry 204 may be instantiated by any other combination of hardware, software, and/or firmware. For example, the pattern identification circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example comparison circuitry 206 compares the pattern to example stored patterns in an example database. For example, the comparison circuitry 206 can compare the pattern associated with the instructions to other example patterns stored in the AI model database 118. In other words, the comparison circuitry 206 can compare the pattern of instructions in the ladder diagram 116 to stored patterns that the AI model learned from training (e.g., by executing the model to apply the learned patterns and/or associations to the process control data). In some examples, the comparison circuitry 206 is instantiated by programmable circuitry executing comparison instructions and/or configured to perform operations such as those represented by the flowchart of FIG. 8.

In some examples, the data transformer circuitry 102 includes means for comparing patterns. For example, the means for comparing may be implemented by comparison circuitry 206. In some examples, the comparison circuitry 206 may be instantiated by programmable circuitry such as the example programmable circuitry 912 of FIG. 9. For instance, the comparison circuitry 206 may be instantiated by an example microprocessor executing machine executable instructions such as those implemented by at least blocks 808, 810 of FIG. 8. In some examples, comparison circuitry 206 may be instantiated by hardware logic circuitry, which may be implemented by an ASIC, XPU, or FPGA circuitry configured and/or structured to perform operations corresponding to the machine readable instructions. Additionally or alternatively, the comparison circuitry 206 may be instantiated by any other combination of hardware, software, and/or firmware. For example, the comparison circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example narrative determination circuitry 208 determines an example control narrative associated with the process control system 104. For example, when the pattern associated with the instructions in the ladder diagram 116 matches at least one of the stored patterns in the AI model database 118, then the narrative determination circuitry 208 can determine the control narrative. In particular, the narrative determination circuitry 208 can determine the control narrative based on the stored control narrative that corresponds to the matching stored pattern in the AI model database 118. In some examples, the narrative determination circuitry 208 determines the control narratives based on similarities between the patterns associated with the instructions from the ladder diagram 116 and stored patterns (e.g., at least one of the stored patterns) in the AI model database 118. In some examples, the narrative determination circuitry 208 is instantiated by programmable circuitry executing narrative determination instructions and/or configured to perform operations such as those represented by the flowchart of FIG. 8.

In some examples, the data transformer circuitry 102 includes second means for determining a control narrative. For example, the second means for determining may be implemented by narrative determination circuitry 208. In some examples, the narrative determination circuitry 208 may be instantiated by programmable circuitry such as the example programmable circuitry 912 of FIG. 9. For instance, the narrative determination circuitry 208 may be instantiated by an example microprocessor executing machine executable instructions such as those implemented by at least blocks 812, 814 of FIG. 8. In some examples, the narrative determination circuitry 208 may be instantiated by hardware logic circuitry, which may be implemented by an ASIC, XPU, or FPGA circuitry configured and/or structured to perform operations corresponding to the machine readable instructions. Additionally or alternatively, the narrative determination circuitry 208 may be instantiated by any other combination of hardware, software, and/or firmware. For example, the narrative determination circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example transmitter circuitry 210 transmits the example control narrative to an example database associated with a DCS. For example, the transmitter circuitry 210 transmits the example control narrative to the DCS database 106 associated with the DCS 108. In this example, the example control narrative can modify (e.g., adjust, control, etc.) a configuration of the DCS 108. For example, when the DCS 108 is employed to manage the process control system 104 (to replace the PLCs 114), the example control narrative may be accessible from other example workstations to access the instructions, the ladder diagram 116, relationships between the field devices 112, the workstation 110, etc., within the process control system 104. In some examples, the transmitter circuitry 210 is instantiated by programmable circuitry executing transmitting instructions and/or configured to perform operations such as those represented by the flowchart of FIG. 8.

In some examples, the data transformer circuitry 102 includes means for transmitting. For example, the means for transmitting may be implemented by transmitter circuitry 210. In some examples, the transmitter circuitry 210 may be instantiated by programmable circuitry such as the example programmable circuitry 912 of FIG. 9. For instance, the transmitter circuitry 210 may be instantiated by an example microprocessor executing machine executable instructions such as those implemented by at least blocks 816, 818 of FIG. 8. In some examples, the transmitter circuitry 210 may be instantiated by hardware logic circuitry, which may be implemented by an ASIC, XPU, or FPGA circuitry configured and/or structured to perform operations corresponding to the machine readable instructions. Additionally or alternatively, the transmitter circuitry 210 may be instantiated by any other combination of hardware, software, and/or firmware. For example, the transmitter circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

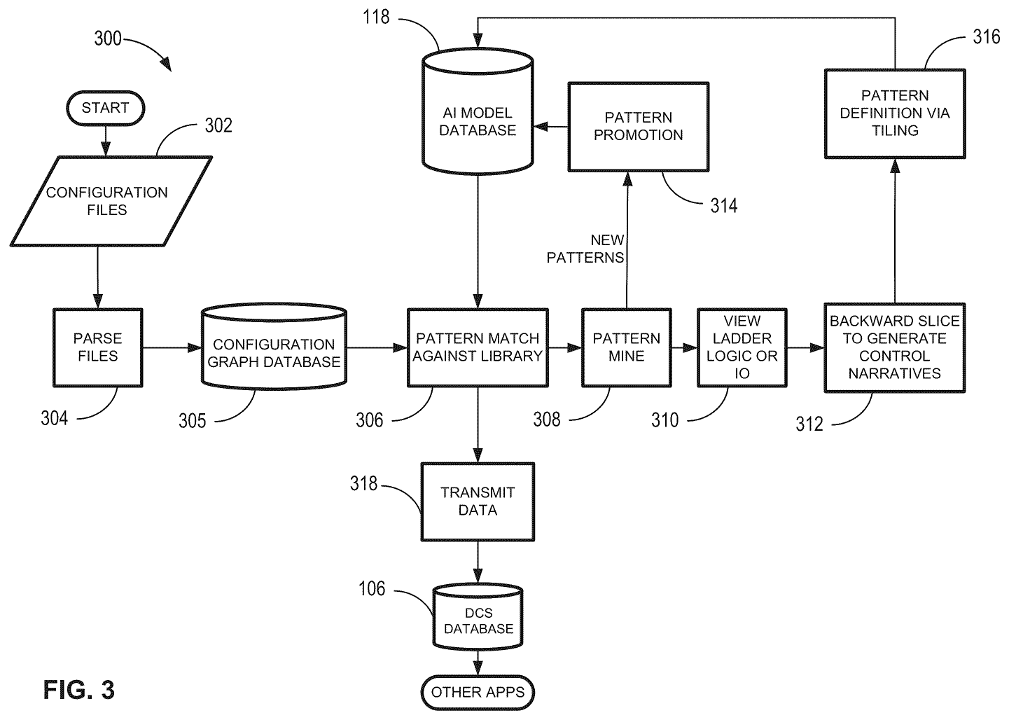

FIG. 3 is an example process flow 300 which the example data transformer circuitry 102 may be implemented. The example process flow begins as the example accessor circuitry 200 accesses example configuration files 302 associated with the process control system 104. In some examples, the configuration files 302 may include process control data. For example, the configuration files 302 may include a list of the field devices 112, information (e.g., sensor data, status indicators, etc.) pertaining to the field devices 112, information pertaining to the workstation 110, instructions and/or commands to manage the process control system 104, the ladder diagram 116, etc. In some examples, the configuration files 302 may be associated with (and/or otherwise provided by) a user or operator of the process control system 104.

The example ladder diagram 116 can be parsed (at block 304) and stored (e.g., saved) in an example configuration graph database 305. In some examples, the ladder diagram 116 is parsed based on the input data, the output conditions, the types of devices (e.g., the field devices 112) involved in the process control system 104, etc. In some examples, the ladder diagram 116 is parsed such that the individual components of the process control system 104 can be analyzed, monitored, or otherwise accessed by the data transformer circuitry 102. In other words, the data transformer circuitry 102 may better analyze patterns within the instructions of the ladder diagram 116 when the ladder diagram 116 is parsed (e.g., divided, organized, etc.) into relatively smaller data files rather than the larger data file associated with the entire ladder diagram 116.

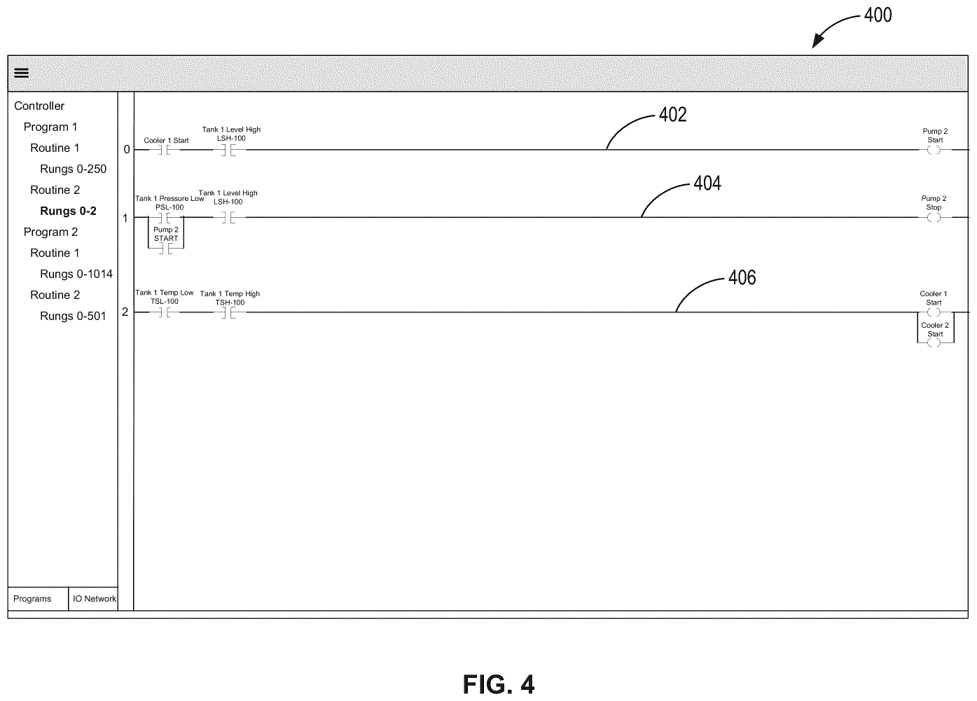

For example, the ladder diagram 116 may be parsed into sets (e.g., lists, groups, etc.) of instructions included in the ladder diagram 116. The example ladder diagram 116 can represent lines of code such as, for example, “for” loops, “and” commands, “or” commands, etc. These different instructions may be parsed from the ladder diagram 116. Further, the ladder diagram 116 can include rungs (described in detail in connection with FIGS. 4-6) that each include machine readable instructions, dependencies, relationships, etc., associated with the process control system 104 and/or field devices 112 in the process control system 104. As such, the example rungs can be parsed from the ladder diagram 116 at block 304.

Accordingly, parsed portions of the configuration files 302 (e.g., the ladder diagram 116) may be stored in the configuration graph database 305. The example configuration graph database 305 stores (e.g., organizes, displays, etc.) data as nodes in a graph. For example, the configuration graph database 305 can store the instructions and/or lines of code associated with the ladder diagram 116 as nodes in a graph. Such an example graph may represent and/or otherwise arrange the process control system 104 in a visual manner. Further, the configuration graph database 305 can access the dependencies between the instructions and, in turn, can arrange (e.g., categorize) the instructions relationally. In other words, the configuration graph database 305 illustrates relationships (e.g., patterns) between instructions of the ladder diagram 116 representing the process control system 104. In some examples, the configuration graph database 305 may record operator activity. For example, the configuration graph database 305 may record activity (e.g., identification information, shift time, preferences, etc.) pertaining to an operator of the workstation 110.

At block 306, the example comparison circuitry 206 compares the pattern(s) associated with the ladder diagram 116 (e.g., the parsed ladder diagram 116) stored in the configuration graph database 305 to stored patterns in the AI model database 118 (e.g., a pattern library database).

For example, the comparison circuitry 206 may query the configuration graph database 305 to access (e.g., view, display, etc.) patterns, relationships, dependencies, etc., associated with the parsed ladder diagram 116. The example configuration graph database 305 is a searchable database that includes a library of patterns. As such, when the comparison circuitry 206 queries the configuration graph database 305, the configuration graph database 305 can return patterns associated with the process control system 104 that were previously parsed from the ladder diagram 116 (block 304). The AI model database 118 may access the configuration graph database 305 to compare patterns of instructions associated with other process control systems to patterns in the configuration graph database 305. Alternatively, the AI model database 118 may include historical patterns associated with the process control system 104.

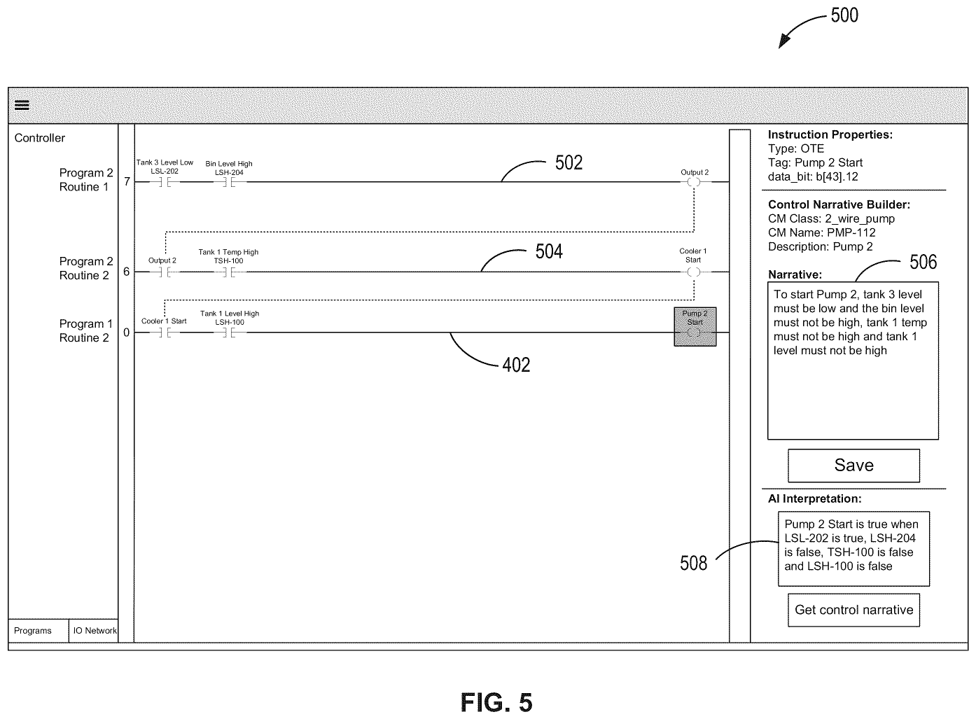

In some examples, the pattern identification circuitry 204 can identify the pattern based on the ladder logic or input/output (IO) instructions (block 310). In other examples, the pattern identification circuitry 204 can employ an example backward slicing process (block 312) to determine dependencies between and/or within the instructions in the ladder diagram 116. For example, the narrative determination circuitry 208 can determine the control narrative based on such example dependencies and any other matching patterns in the AI model database 118. In some examples, the pattern identification circuitry 204 can transmit patterns identified at block 312 and/or the dependencies determined at block 314 to the configuration graph database 305 for storage. The example backward slicing process (block 312) is described in detail in connection with at least FIG. 5.

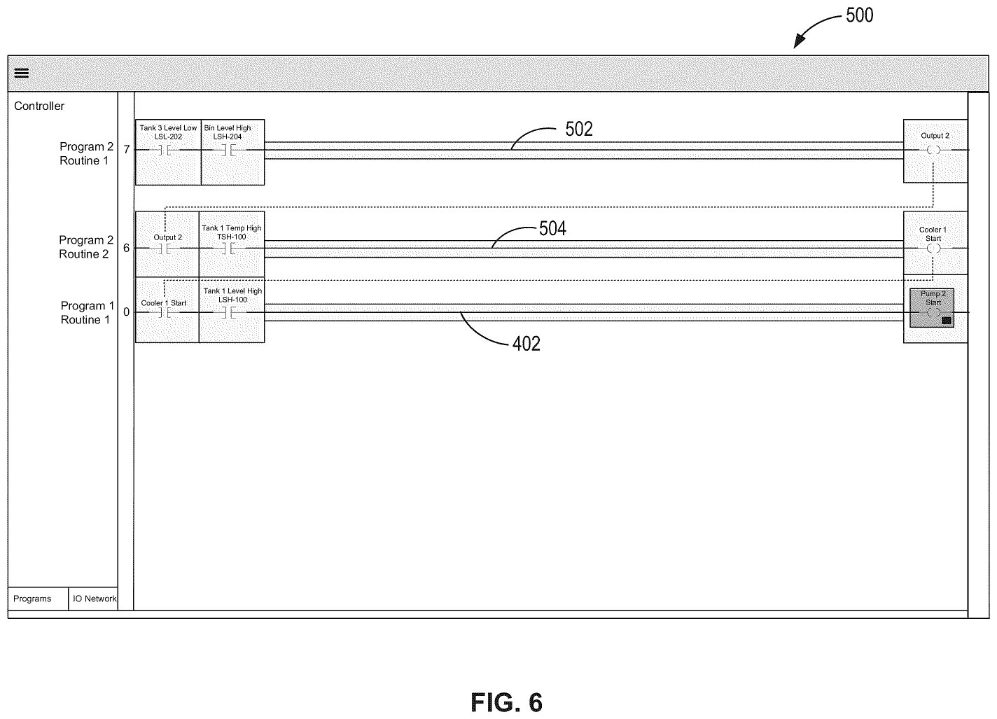

In some examples, the pattern identification circuitry 204 may mine (e.g., extract) new patterns (at block 308) and transmit the new patterns to the AI model database 118 (and/or the configuration graph database 305). For example, if the comparison circuitry 206 determines that the pattern extracted from the ladder diagram 116 (e.g., stored in the configuration graph database 305) does not match at least one of the stored patterns in the AI model database 118, then the pattern identification circuitry 204 can extract the (unmatched) pattern and store the pattern in the AI model database 118. In some examples, the process of transmitting new patterns to the AI model database 118 is referred to as pattern promotion (block 314). Further, the pattern identification circuitry 204 may employ a tiling process (block 316) to define the pattern. The example tiling process is described in detail in connection with at least FIG. 6. At block 318, the example transmitter circuitry 210 transmits (e.g., exports) the example control narrative representing the process control data to the DCS database 106. In some examples, the DCS database 106 transmits the example control narratives (and/or any other process control data associated with the process control system 104) to other applications.

FIGS. 4 and 5 illustrate example ladder diagrams 400, 500 that may be implemented in examples disclosed herein. For example, the example ladder diagrams 400, 500 may be implemented as the ladder diagram 116 presented on the example workstation 110. Turning to FIG. 4, the example ladder diagram 400 includes example rungs 402, 404, 406. The example rung 402 includes example input data “Cooler 1 Start” and “Tank 1 Level Switch High (LSH)—100” to execute the output condition “Pump 2 Start.” In other words, the example instructions associated with the rung 402 include starting cooler 1 and confirming that the Tank 1 has a LSH (e.g., full, not empty, etc.) to start pump 2. The example instructions associated with the rung 404 to turn off Pump 2 may require that either (1) the pressure associated with Tank 1 is low or (2) Pump 2 is not on and (3) confirming that Tank 1 is full. The example instructions associated with the rung 406 to turn on Cooler 1 and Cooler 2 may require that Tank 1 has a low temperature and does not have a high temperature (e.g., that the temperature associated with Tank 1 is between upper and lower thresholds). Such example instructions may be stored and/or transmitted to the configuration graph database 305.

FIG. 5 illustrates the example ladder diagram 500 to execute the rung 402 of FIG. 4. The example ladder diagram 500 includes example rung 502, example rung 504, example narrative 506, and example narrative 508. The example rung 504 includes the input data and/or conditions to turn Cooler 1 “On.” For example, the rung 504 illustrates that “Output 2” be complete and that Tank 1 has a low temperature (e.g., less than a temperature threshold) to turn Cooler 1 “On.” Further, the rung 502 includes the input data and/or conditions to complete “Output 2.” For example, the rung 502 illustrates that Tank 3 is not full (e.g., partially full, empty, low, etc.) and that the Bin Level is High to execute “Output 2.” The example of FIG. 5 illustrates a backwards slicing process to extract the instructions to execute “Pump 2 start.” Further, the example ladder diagram 500 illustrates that an output condition (e.g., Output 2) in a first rung (e.g., the rung 502) can serve as an input condition (e.g., Output 2) in a second rung (e.g., the rung 504). As such, the example instructions associated with the rung 402 depend on the instructions associated with the rungs 502, 504. The example narrative 506 can be implemented as an input (e.g., manual input) field on a user interface of the workstation 110. For example, a user of the workstation 110 can manually insert (e.g., type, dictate, etc.) the control narrative associated with the ladder diagram 500. Alternatively, the example narrative 508 can be a control narrative generated by the example data transformer circuitry 102. In some examples, the narrative 508 is an AI interpretation (e.g., Open AI interpretation) of the ladder diagram 500.

Turning to FIG. 6, the example pattern identification circuitry 204 can identify patterns in the ladder diagram 500 via an example tiling process. In some examples, the pattern identification circuitry 204 can highlight (e.g., color, emphasize, parse, etc.) portions of the example ladder diagram 500 based on category (e.g., inputs, outputs, complete, partially complete, first, second, final, independent, dependent, etc.). In some examples, an example user (e.g., operator, engineer, technician, etc.) can select (e.g., click) the output condition “Pump 2 Start” to view (and/or otherwise have access to) the instructions in the ladder diagram 500 to execute the output condition “Pump 2 Start.” The example comparison circuitry 206 can compare the pattern(s) extracted by the pattern identification circuitry 204 to the AI model database 118. Then, the example narrative determination circuitry 208 can generate the control narrative based on the backward slice and display the result as the narrative 508.

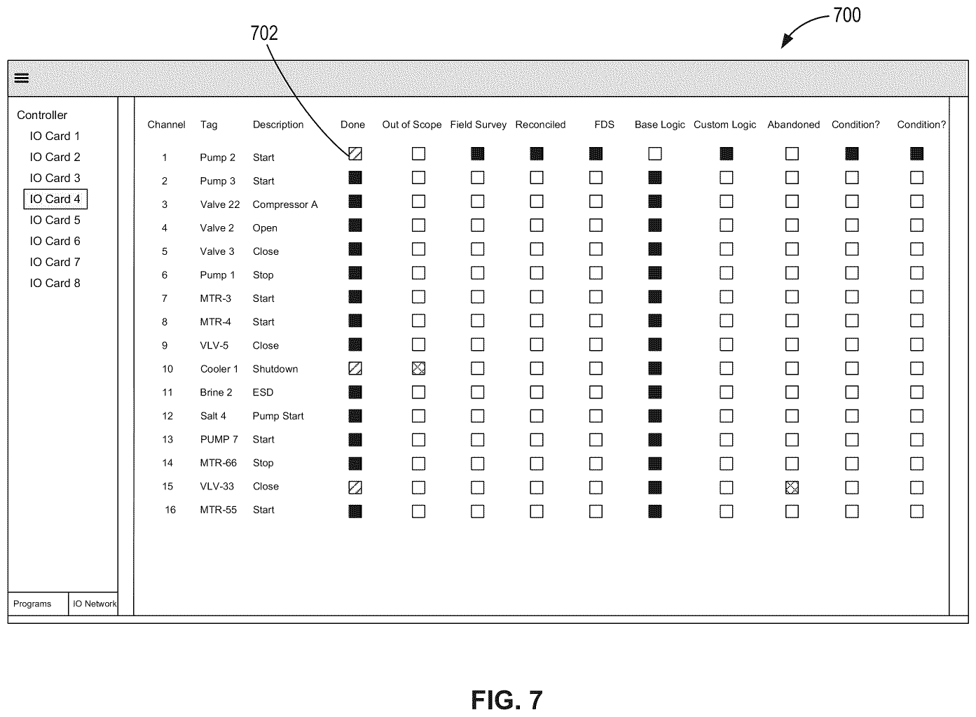

FIG. 7 illustrates an example diagram 700 that demonstrates a plan view of the ladder diagrams 400, 500. For example, the diagram 700 includes status indicators corresponding to different field devices in an example process control system (e.g., field devices 112 in the process control system 104). For example, an example status indicator 702 indicates that the instructions to start Pump 2 (e.g., the ladder diagram 500 and/or rung 402) have been completed. In other examples, the status indicators may indicate that the instructions associated with the field devices may be in progress, stopped, etc.

While an example manner of implementing the data transformer circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example accessor circuitry 200, the example instruction determination circuitry 202, the example pattern identification circuitry 204, the example comparison circuitry 206, the example narrative determination circuitry 208, the example transmitter circuitry 210, and/or, more generally, the example data transformer circuitry 102 of FIG. 2, may be implemented by hardware alone or by hardware in combination with software and/or firmware. Thus, for example, any of the example accessor circuitry 200, the example instruction determination circuitry 202, the example pattern identification circuitry 204, the example comparison circuitry 206, the example narrative determination circuitry 208, the example transmitter circuitry 210, and/or, more generally, the example data transformer circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example data transformer circuitry 102 of FIG. 2 may include one or more elements, processes, and/or devices in addition to, or instead of, those illustrated in FIG. 2, and/or may include more than one of any or all of the illustrated elements, processes and devices.

A flowchart representative of example machine readable instructions, which may be executed by programmable circuitry to implement and/or instantiate the data transformer circuitry 102 of FIG. 2 and/or representative of example operations which may be performed by programmable circuitry to implement and/or instantiate the data transformer circuitry 102 of FIG. 2, are shown in FIG. 8. The machine readable instructions may be one or more executable programs or portion(s) of one or more executable programs for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 8, many other methods of implementing the example data transformer circuitry 102 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations 800 that may be executed, instantiated, and/or performed by programmable circuitry to migrate process control data to a DCS. The example machine-readable instructions and/or the example operations 800 of FIG. 8 begin at block 802, at which the example accessor circuitry 200 accesses an output condition associated with a process control system. For example, the accessor circuitry 200 accesses the example output condition “Pump 2 Start” associated with the process control system 104. In this example, the accessor circuitry 200 accesses the output condition from the ladder diagrams 400, 500. Further, the example field devices 112 include Pump 2.

At block 804, the example instruction determination circuitry 202 determines instructions to control the process control system 104 based on the output condition, the instructions executable by a PLC. For example, the instruction determination circuitry 202 determines instructions from the ladder diagrams 400, 500 based on the output condition “Pump 2 Start.” In this example, the instructions associated with the ladder diagrams 400, 500 are executable by the PLCs 114.

At block 804, the example pattern identification circuitry 204 identifies an example pattern based on the instructions and the output condition. In some examples, the pattern identification circuitry 204 identifies an example pattern by observing (e.g., recording, determining, etc.) dependencies within the instructions. The example pattern identification circuitry 204 can identify the pattern in the ladder diagram 500 based on dependencies between the rungs 402, 502, 504. For example, the pattern identification circuitry 204 can identify that the output condition “Output 2” serves as an input condition in the rung 504. As such, the pattern identification circuitry 204 can identify a pattern in the instructions associated with rung 402 because these instructions depend on the instructions associated with rungs 502, 504.

At block 807, the example pattern identification circuitry 204 can store the pattern in an example configuration graph database (e.g., the configuration graph database 305).

At block 808, the example comparison circuitry 206 compares the pattern to stored patterns in an example AI model database. For example, the comparison circuitry 206 can compare the pattern associated with the ladder diagrams 400, 500 to other example patterns stored in the AI model database 118 (e.g., from training). In some examples, the comparison circuitry 206 queries the configuration graph database 305 to access the pattern. As such, the example comparison circuitry 206 can compare the pattern stored in the configuration graph database 305 with patterns stored in the AI model database 118.

At block 810, the example comparison circuitry 206 determines whether the pattern matches any of the stored patterns in the AI model database 118. If the comparison circuitry 206 determines that the pattern matches at least one of the stored patterns in the AI model database 118, then control proceeds to block 812. For example, when the pattern associated with the instructions in the ladder diagram 500 matches at least one of the stored patterns in the AI model database 118, then control proceeds to block 812. Alternatively, if the comparison circuitry 206 determines that the pattern does not match at least one of the stored patterns in the AI model database 118, then control proceeds to block 814. For example, when the pattern associated with the instructions in the ladder diagram 500 does not match at least of the stored patterns in the AI model database 118, then control proceeds to block 814.

At block 812, the example narrative determination circuitry 208 determines a control narrative based on the matching stored pattern. For example, the narrative determination circuitry 208 can determine the control narrative (e.g., the control narrative 508) based on the stored control narrative that corresponds to the matching stored pattern in the AI model database 118.

At block 814, the example narrative determination circuitry 208 generates an example control narrative. For example, the comparison circuitry 206 may determine that the pattern at least partially matches at least one of stored patterns in the AI model database 118. If the comparison circuitry 206 determines that the pattern partially matches a first one of the stored patterns and partially matches a second one of the stored patterns, then the narrative determination circuitry 208 can generate an example control narrative for the ladder diagram 500 based on the matching portions of the first one and the second one of the stored patterns.

At block 816, the example transmitter circuitry 210 stores the control narrative in the AI model database 118. In some examples, the patterns based on the ladder diagram 500 based be used to train (e.g., retrain) the AI model for future comparisons with the AI model database 118.

At block 818, the example transmitter circuitry 210 transmits the control narrative to the DCS database 106. For example, the transmitter circuitry 210 transmits the narrative 508 to the DCS database 106 to modify a configuration of the DCS 108. Then, the process ends.

FIG. 9 is a block diagram of an example programmable circuitry platform 900 structured to execute and/or instantiate the example machine-readable instructions and/or the example operations of FIG. 8 to implement the data transformer circuitry 102 of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example accessor circuitry 200, the example instruction determination circuitry 202, the example pattern identification circuitry 204, the example comparison circuitry 206, the example narrative determination circuitry 208, and the example transmitter circuitry 210.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIG. 8, may be stored in the mass storage device 928, in the volatile memory 914, in the non-volatile memory 916, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that streamline migration from a PLC process control system application to a DCS application. Examples disclosed herein ensure the database infrastructure associated with the DCS application includes (or can otherwise access) relationships between the different components of the process control system (e.g., the process, alarms, notifications, equipment, field devices, operational displays, etc.). In some examples, disclosed examples ladder diagrams of the process control systems that illustrate (e.g., demonstrate, include, etc.) such relationships. Disclosed systems, apparatus, articles of manufacture, and methods improve the efficiency of using a computing device by substantially reducing or eliminating manual efforts to develop configurations of the updated process control system application. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, first instructions, and programmable circuitry to at least one of instantiate or execute the first instructions to access an output condition associated with a process control system, determine second instructions to control the process control system based on the output condition, the second instructions executable by a programmable logic controller (PLC), identify a pattern based on the second instructions and the output condition, compare the pattern to stored patterns in a first database, the stored patterns associated with at least one other process control system, determine a control narrative associated with the process control system when the pattern matches at least one of the stored patterns in the first database, the control narrative corresponding to the at least one of the stored patterns, and transmit the control narrative to a second database associated with a distributed control system (DCS), the control narrative to modify a configuration of the DCS.

Example 2 includes the apparatus of example 1, wherein the output condition is a first output condition, wherein the first instructions, when executed or instantiated by the programmable circuitry, further cause the programmable circuitry to identify the pattern by accessing input data associated with the first output condition, the input data including a second output condition associated with the process control system, and identifying the pattern based on dependencies between the second output condition, the input data, and the first output condition.

Example 3 includes the apparatus of example 1, wherein the output condition indicates an operation of a field device of the process control system.

Example 4 includes the apparatus of example 1, wherein the first database is a model database associated with an artificial intelligence (AI) model.

Example 5 includes the apparatus of example 4, wherein the first instructions, when executed or instantiated by the programmable circuitry, further cause the programmable circuitry to query a configuration graph database to access the pattern, the configuration graph database storing the pattern, and compare the pattern in the configuration graph database to stored patterns in the model database.

Example 6 includes the apparatus of example 1, wherein the second instructions are associated with a graphical programming language.

Example 7 includes the apparatus of example 6, wherein the graphical programming language is associated with a ladder diagram.

Example 8 includes the apparatus of example 7, wherein the first instructions, when executed or instantiated by the programmable circuitry, further cause the programmable circuitry to access the output condition by accessing the ladder diagram.

Example 9 includes a non-transitory machine readable storage medium comprising first instructions to cause programmable circuitry to at least access an output condition associated with a process control system, determine second instructions to control the process control system based on the output condition, the second instructions executable by a programmable logic controller (PLC), identify a pattern based on the second instructions and the output condition, compare the pattern to stored patterns in a first database, the stored patterns associated with at least one other process control system, determine a control narrative associated with the process control system when the pattern matches at least one of the stored patterns in the first database, the control narrative corresponding to the at least one of the stored patterns, and transmit the control narrative to a second database associated with a distributed control system (DCS), the control narrative to modify a configuration of the DCS.

Example 10 includes the non-transitory machine readable storage medium of example 9, wherein the output condition is a first output condition, wherein the first instructions, when executed or instantiated by the programmable circuitry, further cause the programmable circuitry to identify the pattern by accessing input data associated with the first output condition, the input data including a second output condition associated with the process control system, and identifying the pattern based on dependencies between the second output condition, the input data, and the first output condition.

Example 11 includes the non-transitory machine readable storage medium of example 9, wherein the output condition indicates an operation of a field device of the process control system.

Example 12 includes the non-transitory machine readable storage medium of example 9, wherein the first database is a model database associated with an artificial intelligence (AI) model.

Example 13 includes the non-transitory machine readable storage medium of example 12, wherein the first instructions, when executed or instantiated by the programmable circuitry, further cause the programmable circuitry to query a configuration graph database to access the pattern, the configuration graph database storing the pattern, and compare the pattern in the configuration graph database to stored patterns in the model database.

Example 14 includes the non-transitory machine readable storage medium of example 9, wherein the second instructions are associated with a graphical programming language.

Example 15 includes the non-transitory machine readable storage medium of example 14, wherein the graphical programming language is associated with a ladder diagram.

Example 16 includes the non-transitory machine readable storage medium of example 15, wherein the first instructions, when executed or instantiated by the programmable circuitry, further cause the programmable circuitry to access the output condition by accessing the ladder diagram.

Example 17 includes a method comprising accessing an output condition associated with a process control system, determining instructions to control the process control system based on the output condition, the instructions executable by a programmable logic controller (PLC), identifying a pattern based on the instructions and the output condition, comparing the pattern to stored patterns in a first database, the stored patterns associated with at least one other process control system, determining a control narrative associated with the process control system when the pattern matches at least one of the stored patterns in the first database, the control narrative corresponding to the at least one of the stored patterns, and transmitting the control narrative to a second database associated with a distributed control system (DCS), the control narrative to modify a configuration of the DCS.

Example 18 includes the method of example 17, wherein the output condition is a first output condition, further including identifying the pattern by accessing input data associated with the first output condition, the input data including a second output condition associated with the process control system, and identifying the pattern based on dependencies between the second output condition, the input data, and the first output condition.

Example 19 includes the method of example 17, wherein the first database is a model database associated with an artificial intelligence (AI) model.

Example 20 includes the method of example 17, wherein the instructions are associated with a graphical programming language.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
first instructions; and
programmable circuitry to at least one of instantiate or execute the first instructions to:
access an output condition associated with a process control system;
determine second instructions to control the process control system based on the output condition, the second instructions executable by a programmable logic controller (PLC);
identify a pattern based on the second instructions and the output condition;
compare the pattern to stored patterns in a first database, the stored patterns associated with at least one other process control system;
determine a control narrative associated with the process control system when the pattern matches at least one of the stored patterns in the first database, the control narrative corresponding to the at least one of the stored patterns; and
transmit the control narrative to a second database associated with a distributed control system (DCS), the control narrative to modify a configuration of the DCS.

2. The apparatus of claim 1, wherein the output condition is a first output condition, wherein the first instructions, when executed or instantiated by the programmable circuitry, further cause the programmable circuitry to identify the pattern by:
accessing input data associated with the first output condition, the input data including a second output condition associated with the process control system; and
identifying the pattern based on dependencies between the second output condition, the input data, and the first output condition.

3. The apparatus of claim 1, wherein the output condition indicates an operation of a field device of the process control system.

4. The apparatus of claim 1, wherein the first database is a model database associated with an artificial intelligence (AI) model.

5. The apparatus of claim 4, wherein the first instructions, when executed or instantiated by the programmable circuitry, further cause the programmable circuitry to:
query a configuration graph database to access the pattern, the configuration graph database storing the pattern; and
compare the pattern in the configuration graph database to stored patterns in the model database.

6. The apparatus of claim 1, wherein the second instructions are associated with a graphical programming language.

7. The apparatus of claim 6, wherein the graphical programming language is associated with a ladder diagram.

8. The apparatus of claim 7, wherein the first instructions, when executed or instantiated by the programmable circuitry, further cause the programmable circuitry to access the output condition by accessing the ladder diagram.

9. A non-transitory machine readable storage medium comprising first instructions to cause programmable circuitry to at least:
access an output condition associated with a process control system;
determine second instructions to control the process control system based on the output condition, the second instructions executable by a programmable logic controller (PLC);
identify a pattern based on the second instructions and the output condition;
compare the pattern to stored patterns in a first database, the stored patterns associated with at least one other process control system;
determine a control narrative associated with the process control system when the pattern matches at least one of the stored patterns in the first database, the control narrative corresponding to the at least one of the stored patterns; and
transmit the control narrative to a second database associated with a distributed control system (DCS), the control narrative to modify a configuration of the DCS.

10. The non-transitory machine readable storage medium of claim 9, wherein the output condition is a first output condition, wherein the first instructions, when executed or instantiated by the programmable circuitry, further cause the programmable circuitry to identify the pattern by:
accessing input data associated with the first output condition, the input data including a second output condition associated with the process control system; and
identifying the pattern based on dependencies between the second output condition, the input data, and the first output condition.

11. The non-transitory machine readable storage medium of claim 9, wherein the output condition indicates an operation of a field device of the process control system.

12. The non-transitory machine readable storage medium of claim 9, wherein the first database is a model database associated with an artificial intelligence (AI) model.

13. The non-transitory machine readable storage medium of claim 12, wherein the first instructions, when executed or instantiated by the programmable circuitry, further cause the programmable circuitry to:
query a configuration graph database to access the pattern, the configuration graph database storing the pattern; and
compare the pattern in the configuration graph database to stored patterns in the model database.

14. The non-transitory machine readable storage medium of claim 9, wherein the second instructions are associated with a graphical programming language.

15. The non-transitory machine readable storage medium of claim 14, wherein the graphical programming language is associated with a ladder diagram.

16. The non-transitory machine readable storage medium of claim 15, wherein the first instructions, when executed or instantiated by the programmable circuitry, further cause the programmable circuitry to access the output condition by accessing the ladder diagram.

17. A method comprising:
accessing an output condition associated with a process control system;
determining instructions to control the process control system based on the output condition, the instructions executable by a programmable logic controller (PLC);
identifying a pattern based on the instructions and the output condition;
comparing the pattern to stored patterns in a first database, the stored patterns associated with at least one other process control system;
determining a control narrative associated with the process control system when the pattern matches at least one of the stored patterns in the first database, the control narrative corresponding to the at least one of the stored patterns; and
transmitting the control narrative to a second database associated with a distributed control system (DCS), the control narrative to modify a configuration of the DCS.

18. The method of claim 17, wherein the output condition is a first output condition, further including identifying the pattern by:
accessing input data associated with the first output condition, the input data including a second output condition associated with the process control system; and
identifying the pattern based on dependencies between the second output condition, the input data, and the first output condition.

19. The method of claim 17, wherein the first database is a model database associated with an artificial intelligence (AI) model.

20. The method of claim 17, wherein the instructions are associated with a graphical programming language.
